(19) United States
(12) Patent Application Publication
(10) Pub. No.: US 2010/0190024 A1
(43) Pub. Date: Jul. 29, 2010

(54) SINTERED COPPER-BASED MATERIAL HAVING INCREASED GRAIN SIZE AND METHOD OF MAKING THE SAME

(75) Inventors: William L. Edwards, JR., DuBois, PA (US); David L. Freeman, JR., Brockway, PA (US)

Correspondence Address: TUROCY & WATSON, LLP, 127 Public Square, 57th Floor, Key Tower, CLEVELAND, OH, 44114, US

(73) Assignee: NetShape Technologies, Inc, Sellersburg, IN (US)

(21) Appl. No.: 12/693,887

(22) Filed: Jan. 26, 2010

Related U.S. Application Data
(60) Provisional application No. 61/147,262, filed on Jan. 26, 2009.

(51) Int. Cl. B32B 15/01; B32B 15/02; B22F 3/12

(52) U.S. Cl. 428/546; 419/38

(57) ABSTRACT

Disclosed are sintered copper-based materials and methods for forming the same having a larger grain size than materials formed through conventional methods. A metal powder having copper is compressed, pre-heated, and then sintered. Then, the density of the once sintered copper-based material is sized to increase density and subjected to a second sintering act. The sintered copper-based materials have a grain size of at least 50 μm.

### CROSS-REFERENCE TO RELATED APPLICATIONS

This application claims the benefit of U.S. Provisional Patent Application Ser. No. 61/147,262, filed Jan. 26, 2009, the entirety of which is herein incorporated by reference.

### TECHNICAL FIELD

This disclosure relates to sintered metal materials formed from powder copper components having improved physical properties, and related methods.

### BACKGROUND

Powder metallurgy or sintering processes are typically employed in the manufacturing of articles having irregular curves or recesses that are difficult to machine from a single ingot of metal. An article can be manufactured in a form close to its final shape by placing powdered metal into an enclosed die having a shape similar to the final shape of the article. The powdered metal within the die is subjected to pressure and heating, at a temperature typically below the melting point of the metal, to form a solid metal article.

During the sintering process, neighboring metal powder particles diffuse together in a solid state followed by recrystallization. Using such procedures, a solid metal article of manufacture having a microscopic crystal structure can be directly formed into a final shape without passing through a molten state. However, articles manufactured using sintering techniques often have certain inferior physical properties compared to articles made through molten metal or wrought metal techniques.

### SUMMARY

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

Powdered metal metallurgy is a technique for forming solid metal materials and articles of manufacture from physically powdered materials forming numerous individual particles. Solid metal materials are formed from applying pressure and/or heat to physically powdered materials. One method for accomplishing the fabrication is sintering, wherein pressure and heat is applied less than the melting point of the component metals. Often, metal materials formed from sintering have a characteristically small grain size; grains are regions of crystal regularity within the metal structure bounded by regions where the regularity of the crystal pattern has become misaligned. Techniques are disclosed for forming sintered copper-based materials having a grain size about 10 times larger than sintered copper-based materials formed through conventional techniques.

One aspect of the invention relates to methods for forming sintered copper-based materials. A metal powder comprising copper is compacted at an ambient temperature and optionally later heated at a temperature of at least about 400° C. under an atmosphere having at least about 5% hydrogen by partial pressure with the remainder of the atmosphere having one or more selected from nitrogen and noble gas. The compacted material is sintered at a temperature from about 950 to about 1084° C. under an atmosphere having at least about 5% hydrogen by partial pressure with the remainder being one or more selected from nitrogen and a noble gas for a time period of at least about 45 minutes to form a once sintered copper-based material. The once sintered copper-based material is sized by applying pressure to increase the density to a range from about 8.4 to about 8.9 g/cc. Then, an additional sintering is performed at a temperature from about 950 to about 1084° C. under an atmosphere having at least about 5% hydrogen by pressure with the remainder being one or more selected from nitrogen and a noble gas for a time period of at least about 45 minutes. A sintered copper-based material is recovered having a grain size greater than 50μm.

Another aspect of the invention relates to methods of increasing tensile strength, increasing resistance to distortion, and/or decreasing material creep of a sintered copper-based material by compacting a metal powder comprising copper; sintering the compacted metal powder; applying pressure to size the once sintered copper-based material; and sintering the once sintered and sized copper-based material.

Yet another aspect of the invention relates to sintered copper-based materials formed from a powdered metal having a crystallized metal matrix formed from a powdered metal comprising at least about 70% by weight copper, the crystallized metal matrix comprising grains where at least 80% by weight of the grains have a grain size greater than 50 μm.

### BRIEF DESCRIPTION OF DRAWINGS

FIG. 1 depicts a micrograph of a sintered copper-based material formed by conventional techniques.

FIG. 2 depicts a micrograph of a sintered copper-based material formed in accordance with one aspect of the invention.

FIG. 3 depicts a micrograph of wrought copper.

FIG. 4 illustrates an exemplary methodology of forming sintered copper-based materials in accordance with some aspects of the invention.

### DETAILED DESCRIPTION

The copper and copper alloy-based materials and sintering methods disclosed herein are directed toward solid copper and copper alloy-based materials of manufacture having a grain size comparable to copper and copper alloy articles of manufacture formed using conventional wrought copper techniques. The advantages obtained using the copper and copper alloy-based materials and methods disclosed herein include, but are not limited to, increased tensile strength at temperatures greater than about 400° C., increased resistance to distortion at temperatures greater than about 400° C., and lower material creep at temperatures greater than about 400° C. compared to copper materials formed using conventional sintering techniques.

As used throughout this disclosure, the term “sintered copper-based material” is herein defined as a solid material formed from at least one powdered component that comprises copper and includes solid materials formed from copper and copper alloys.

As used throughout this disclosure, the terms “grain size” and “maximum dimension of a grain” refers to the largest width of a grain comprising a solid metallic material regardless of the geometry of the grain. As used throughout this disclosure, the term “ambient temperature” refers to performing at act a temperature tolerable to an individual, typically less than about 40° C.

The copper-based materials disclosed herein are formed using a compaction act wherein powdered metal is placed into a mold under pressure at an ambient temperature; an optional pre-heating act wherein the compacted copper powder is heated to a temperature of about 350° C. to about 650° C.; a first sintering act wherein the compacted copper powder is heated to a temperature of about 1000° C. to about 1100° C.; a sizing step wherein the sintered copper formed from the first sintering act is placed under pressure to reduce porosity and increase density; and a second sintering act wherein the sintered copper or copper alloy is heated to a temperature of about 1000° C. to about 1100° C.

In one embodiment, the starting material is one or more metal powders having a mean particle diameter of less than about 25 μm. In another embodiment, the one or more metal powders have a mean particle diameter from about 1 μm to about 25 μm. In yet another embodiment, the one or more metal powders have a mean particle diameter from about 5 μm to about 15 μm. In still yet another embodiment, the one or more metal powders have a mean particle diameter from about 5 μm to about 12 μm.

In one embodiment, the one or more metal powders are substantially pure copper. In another embodiment, the one or more metal powders comprise a mixture of a substantially pure copper powder and a powder of an alloy metal and/or a powder of a copper alloy comprising one or more alloy metals, wherein mixture comprises about 70% by weight or more by of copper. In yet another embodiment, the one or more metal powders comprise about 80% by weight or more copper. In still yet another embodiment, the one or more metal powders comprise about 90% by weight or more copper. In a further embodiment, the one or more metal powder comprise from about 70% to about 100% by weight copper. In a still further embodiment, the one or more metal powders comprise from about 80% to about 100% by weight copper. In an even still further embodiment, the one or more metal powders comprise from about 90% to about 100% by weight copper. In a further embodiment, the one or more metal powders comprise from about 80% to about 95% by weight copper. In a still further embodiment, the one or more metal powders comprise from about 80% to about 95% by weight copper.

Examples of alloy metals include zinc, nickel, tin, chromium, iron, cobalt, titanium and lead. In one embodiment, the sintered copper-based material comprises one phase comprising one or more of a crystalline phase comprising copper and a crystalline phase comprising copper and one or more alloy metals. In another embodiment, the sintered copper-based material comprises two or more phases, wherein a first copper-based phase is one or more selected from a crystalline phase comprising copper and a crystalline phase comprising copper and one or more alloy metals and a second phase comprises a stellite alloy. The first copper-based phase is formed from powdered copper and/or powdered alloy metal as described above. Stellite alloys are well-known in the art and comprise a cobalt alloy typically alloyed with chromium and/or tungsten with a minor amount of carbon. In one embodiment, the copper-based phase comprises about 70% or more by weight of the copper-based material. In another embodiment, the copper-based phase comprises about 80% or more by weight of the copper-based material.

The one or more powdered metals are placed in a mold appropriate for the shape of the desired final copper-based article of manufacture. The one or more powdered metals within the mold are compacted at ambient temperature by applying pressure such that the density of powdered materials is increased to a range from about 6.7 to about 7.3 g/cc. In another embodiment, the one or more powdered metals are by applying pressure at a range from about 6.9 to about 7.2 g/cc. In yet another embodiment, the one or more powdered metals are by applying pressure at a range from about 7 to about 7.1 g/cc. Without wishing to be bound by any one theory, it is believed that using a higher compaction pressure than found in conventional process decreases void space allowing for improved grain growth during the sintering acts.

The die containing the compressed metal starting materials is next subjected to an optional pre-heating act in an oven. The oven atmosphere is from about 5 to about 100% hydrogen by partial pressure with the balance of the atmosphere comprising one or inert gases such as nitrogen or a noble gas. In another embodiment, the oven atmosphere is from about 80 to about 100% hydrogen by partial pressure. In yet another embodiment, the oven atmosphere is from about 90 to about 100% hydrogen by partial pressure. In one embodiment, the oven atmosphere is from 1 to about 1.2 atm to allow for venting of the oven atmosphere to keep ambient air out of the oven. The same oven atmosphere can apply to all pre-heating and sintering acts performed in an oven or heating chamber.

In one embodiment, the optional pre-heating is performed at a temperature of about 400° C. or greater. In another embodiment, the optional pre-heating is performed at a temperature of about 450° C. or greater. In still another embodiment, the optional pre-heating is performed at a temperature of about 470° C. or greater.

In a further embodiment, the optional pre-heating is performed at a temperature from about 400 to about 550° C. In a still further embodiment, the optional pre-heating is performed at a temperature from about 450 to about 500° C. In an even still further embodiment, the optional pre-heating is performed at a temperature from about 470 to about 490° C. In one embodiment, the optional pre-heating is performed for about 20 minutes or longer. In another embodiment, the optional pre-heating is performed for about 30 minutes or longer. In yet another embodiment, the optional pre-heating is performed from about 20 to about 60 min. In still yet another embodiment, the optional pre-heating is performed from about 30 to about 60 min. In a further embodiment, the optional pre-heating is performed from about 30 to about 45 min.

After completion of the optional pre-heating, if performed, the compressed metal materials undergo a first sintering act by moving the metal materials directly to an oven having a higher temperature without a time interval that allows for cooling of the metal materials (for example, so as to not allow a temperature decrease of more than 25° C. or more than 10° C.). One method of accomplishing the transition to the first sintering act is to employ an oven having two temperature zones, wherein a conveyor belt or the like is used to move the metal materials from a first temperature zone to a second temperature zone without exposing the metal materials to any or substantial amounts of air.

In one embodiment, the sintering is performed at a temperature from about 950 to about 1084° C. In another embodiment, the sintering is performed at a temperature from about 1000 to about 1084° C. In yet another embodiment, the sintering is performed at a temperature from about 1040 to about 1070° C. In one embodiment, the sintering is performed for at least about 45 minutes. In another embodiment, the sintering is performed for at least about 50 minutes. In yet another embodiment, the pre-heating is performed for at least about 60 minutes. In still yet another embodiment, the pre-heating is performed from about 45 to about 120 minutes.

After sintering, a sizing act is performed to increase the density of the sintered material and reduce void volume in the microstructure of the sintered material. Sizing is performed at a temperature substantially cooler than either of the preceding pre-heating and sintering acts and can be performed under any atmosphere. In one embodiment, sizing is performed at about room temperature. In another embodiment, sizing is performed from about 20 to about 100° C. Sizing is accomplished by applying suitable pressure to achieve a density from about 8.4 to 8.9 g/cc in the once sintered material. In another embodiment, sizing is accomplished by applying pressure to achieve a density from about 8.5 to 8.8 g/cc in the once sintered material.

After the sizing act, a second optional pre-heating and sintering act is performed on the sized and once sintered copper-based material. In one embodiment, the second optional pre-heating is performed at a temperature from about 400 to about 550° C. (this act can be the first pre-heating act, if the above-described optional pre-heating act before the first sintering act is not performed). In another embodiment, the second optional pre-heating is performed at a temperature from about 450 to about 500° C. In yet another embodiment, the second optional pre-heating is performed at a temperature from about 470 to about 490° C. In one embodiment, the second optional pre-heating is performed from about 20 to about 60 min. In another embodiment, the second optional pre-heating is performed from about 30 to about 60 min. In yet another embodiment, the second optional pre-heating is performed from about 30 to about 45 min.

The second pre-heating and sintering acts are performed at the same, higher or lower partial pressure of hydrogen than the first pre-heating and sintering acts. In one embodiment, the second pre-heating and sintering acts are performed under a lower partial pressure of hydrogen than the first pre-heating and sintering acts. Using a lower hydrogen partial pressure in the second pre-heating and sintering acts reduces the amount of water formed by reaction between hydrogen and trace amounts of oxygen, thereby reducing the amount of water and/or hydrogen that can potentially become trapped within the porosity of the copper-based materials and weakening the material.

In one embodiment, the second pre-heating and sintering acts are performed under at least a 5% lower partial pressure of hydrogen than the first pre-heating and sintering acts. In another embodiment, the second pre-heating and sintering acts are performed under at least a 10% lower partial pressure of hydrogen than the first pre-heating and sintering acts. In yet another embodiment, the first pre-heating and sintering acts are independently performed under an atmosphere comprising about 95 to about 100% hydrogen by partial pressure. In still yet another embodiment, the second pre-heating and sintering acts are independently performed under an atmosphere comprising about 50 to about 80% hydrogen by partial pressure.

The innovation is now described with reference to the Figures, specific embodiments, and comparative Examples. Using the above-described techniques, sintered copper-based materials having a surprising increase are achieved. Unless otherwise indicated in the following examples and elsewhere in the specification and claims, all parts and percentages are by weight, all temperatures are in degrees Centigrade, and pressure is at or near atmospheric pressure.

### Comparative Example 1

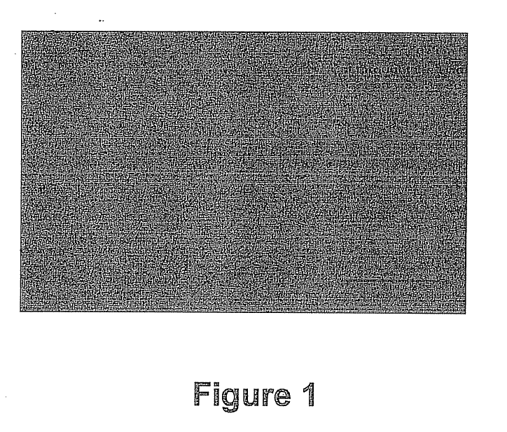

FIG. 1 depicts the grain structure of a 100% copper sintered material formed through a conventional process. The observed grains have a maximum dimension from about 3 to about 20 μm. The comparative example is formed by compacting copper powder having an average diameter of 10 μm in a mold to a density of about 6.7 g/cc. The compacted sample is then preheated at a temperature of about 482° C. for about 15 minutes under an atmosphere of about 25% hydrogen and about 75% nitrogen. The sample is then sintered at a temperature of about 1038° C. for about 30 minutes under an atmosphere of 25% hydrogen and about 75% nitrogen. Pressure is then applied to size the sintered sample to a density of about 8.6 g/cc.

### Inventive Example

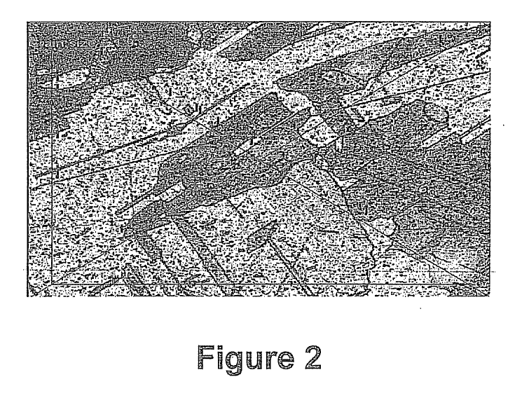

FIG. 2 depicts the grain structure of a 100% copper sintered material formed in accordance with one aspect of the innovations disclosed herein. The observed grains have a maximum dimension from about 125 to about 250 μm. The comparative example is formed by compacting copper powder having an average diameter of 10 μm in a mold to a density of about 6.9 g/cc. The compacted sample is then preheated at a temperature of about 482° C. for about 15 minutes under an atmosphere of about 100% hydrogen. The sample is then sintered at a temperature of about 1038° C. for about 50 minutes under an atmosphere of about 100% hydrogen. Then, the sample is allowed to cool to room temperature and pressure is then applied to size the sintered sample to a density of about 8.7 g/cc. Then, a second pre-heating act is performed at a temperature of about 482° C. for about 15 minutes under an atmosphere of about 75% hydrogen and about 25% nitrogen. Finally, a second sintering step is performed at a temperature of about 1038° C. for about 50 minutes under an atmosphere of about 75% hydrogen and 25% nitrogen.

During sintering, individual metal particles bond through a process of diffusion at temperatures below the melting temperature of copper, which is 1084.6° C. Sintering proceeds first by necking or bridging between neighboring particles wherein individual particles maintain unique identity. Individual metal particles then diffuse together and recrystallize to form individual grains within the copper-based material. Without wishing to be bound by any one theory, it is believed that performance of the sizing act reduces void space within the microstructure of the material and brings additions areas of the microstructure into contact. An additional sintering step then leads to further diffusion and grain growth. The remarkable increase in grain size between Comparative Example 1 and the Inventive Example is an unexpected result that is believed to a product of the combination of the sizing act and the additional sintering act.

### Comparative Example 2

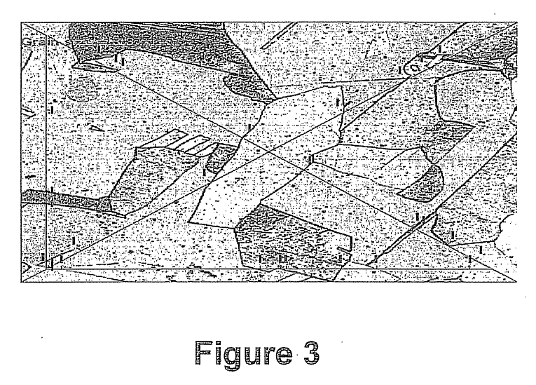

FIG. 3 depicts the grain structure of a wrought copper barstock meeting the specifications of Unified Numbering System C10100. The observed grains have a maximum dimension from about 150 to about 300 μm. As can be observed, the grain size of the Inventive Example is substantially similar to the grain size of wrought copper found in Comparative Example 1.

Those skilled in the art will readily recognize that the actual grain size obtained using the innovations disclosed herein will vary depending upon the nature of the powder copper and powder alloy metal metals selected for sintering and variables selected, including and not limited to identity of alloy metals, powder particle size, temperature, atmosphere and times for pre-heating and sintering. In one embodiment, at least about 80% by weight of the grains in the sintered copper-based material have a maximum dimension greater than about 50 μm. In another embodiment, at least about 80% by weight of the grains in the sintered copper-based material have a maximum dimension greater than about 75 μm. In yet another embodiment, at least about 80% by weight of the grains in the sintered copper-based material have a maximum dimension greater than about 100 μm. In a further embodiment, at least about 80% by weight of the grains in the sintered copper-based material have a maximum dimension greater than about 125 μm. In a still further embodiment, at least about 80% by weight of the grains in the sintered copper-based material have a maximum dimension from about 50 to about 350 μm. In an even further embodiment, at least about 80% by weight of the grains in the sintered copper-based material have a maximum dimension from about 100 to about 300 μm. In an even still further embodiment, at least about 80% by weight of the grains in the sintered copper-based material have a maximum dimension from about 100 to about 250 μm.

In one embodiment, at least about 90% by weight of the grains in the sintered copper-based material have a maximum dimension greater than about 50 μm. In another embodiment, at least about 90% by weight of the grains in the sintered copper-based material have a maximum dimension greater than about 75 μm. In yet another embodiment, at least about 90% by weight of the grains in the sintered copper-based material have a maximum dimension greater than about 100 μm. In a further embodiment, at least about 90% by weight of the grains in the sintered copper-based material have a maximum dimension greater than about 125 μm. In a still further embodiment, at least about 90% by weight of the grains in the sintered copper-based material have a maximum dimension from about 50 to about 350 μm. In an even further embodiment, at least about 90% by weight of the grains in the sintered copper-based material have a maximum dimension from about 100 to about 300 μm. In an even still further embodiment, at least about 90% by weight of the grains in the sintered copper-based material have a maximum dimension from about 100 to about 250 μm.

In one embodiment, the grains in the sintered copper-based material have a maximum dimension greater than about 50 μm. In another embodiment, the grains in the sintered copper-based material have a maximum dimension greater than about 75 μm. In yet another embodiment, the grains in the sintered copper-based material have a maximum dimension greater than about 100 μm. In a further embodiment, the grains in the sintered copper-based material have a maximum dimension greater than about 125 μm. In a still further embodiment, the grains in the sintered copper-based material have a maximum dimension from about 50 to about 350 μm. In an even further embodiment, the grains in the sintered copper-based material have a maximum dimension from about 100 to about 300 μm. In an even still further embodiment, the grains in the sintered copper-based material have a maximum dimension from about 100 to about 250 μm.

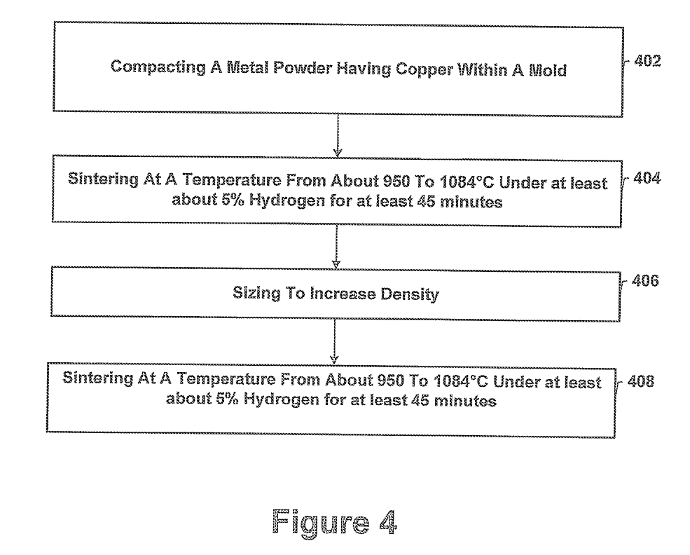

Referring to FIG. 4, acts to produce sintered copper-based materials in accordance with aspects of the invention are presented. In act 402, a metal powder having copper is compacted within a mold. In act 404, the metal powder is sintered at a temperature from about 950 to about 1084° C. under an atmosphere of at least about 5% hydrogen for a time period of at least about 45 minutes to form a once sintered copper-based material. In act 406, the once sintered copper-based material from act 404 is sized by applying pressure to increase density. In act 408, the once sintered and sized copper-based material is sintered a second time at a temperature from about 950 to about 1084° C. under an atmosphere of at least about 5% hydrogen for a time period of at least about 45 minutes to form a sintered copper-based material in accordance with an aspect of the invention.

With respect to any figure or numerical range for a given characteristic, a figure or a parameter from one range may be combined with another figure or a parameter from a different range for the same characteristic to generate a numerical range.

Other than in the operating examples, or where otherwise indicated, all numbers, values and/or expressions referring to quantities of ingredients, reaction conditions, etc., used in the specification and claims are to be understood as modified in all instances by the term “about.”

While the invention has been explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

What is claimed is:

1. A method for forming a sintered copper-based material, comprising:
compacting a metal powder comprising at least about 80% by weight copper;
sintering the compacted metal powder at a temperature from about 950 to about 1084° C. under an atmosphere comprising at least about 5% hydrogen by partial pressure with the remainder being one or more selected from nitrogen and a noble gas for a time period of at least about 45 minutes to form a once sintered copper-based material;
applying pressure to size the once sintered copper-based material to a density from about 8.4 to 8.9 g/cc to form a once sintered and sized copper-based material;
sintering the once sintered and sized copper-based material at a temperature from about 950 to about 1084° C. under an atmosphere comprising at least about 5% hydrogen by partial pressure with the remainder being one or more selected from nitrogen and a noble gas for a time period of at least about 45 minutes to form a sintered copper-based material having a grain size greater than 50 μm.

2. The method according to claim 1, further comprising
heating the compacted metal powder at a temperature of at least about 400° C. under an atmosphere comprising at least about 5% hydrogen by partial pressure with the remainder being one or more selected from nitrogen and a noble gas after the compacting act and before the first sintering act; and
heating the sized copper-based material at a temperature of at least about 400° C. under an atmosphere comprising at least about 5% hydrogen by partial pressure with the remainder being one or more selected from nitrogen and a noble gas after the pressure application act and before the second sintering act.

3. The method according to claim 1, wherein the second sintering act is performed under at least a 5% lower partial pressure of hydrogen than the first sintering act.

4. The method according to claim 2, wherein the second heating act is performed under at least a 5% lower partial pressure of hydrogen than the first heating act.

5. The method according to claim 1, wherein compacting the metal powder comprises applying pressure at a density from about 6.7 to 7.3 g/cc.

6. The method according to claim 1, wherein compacting the metal powder comprises applying pressure at a density from about 6.9 to 7.2 g/cc.

7. The method according to claim 1, wherein the first sintering act is performed in an atmosphere comprising from about 80 to about 100% hydrogen by partial pressure.

8. The method according to claim 1, wherein the second sintering act is performed in an atmosphere comprising from about 50 to about 80% hydrogen by partial pressure.

9. The method according to claim 1, wherein the first and second sintering acts are each independently performed for a time period of at least about 50 minutes.

10. A method of increasing tensile strength, increasing resistance to distortion, and/or decreasing material creep of a sintered copper-based material, comprising:
compacting a metal powder comprising at least about 80% by weight copper;
sintering the compacted metal powder at a temperature from about 950 to about 1084° C. under an atmosphere comprising at least about 5% hydrogen by partial pressure with the remainder being one or more selected from nitrogen and a noble gas for a time period of at least about 45 minutes to form a once sintered copper-based material;
applying pressure to size the once sintered copper-based material to a density from about 8.4 to 8.9 g/cc to form a once sintered and sized copper-based material;
sintering the once sintered and sized copper-based material at a temperature from about 950 to about 1084° C. under an atmosphere comprising at least about 5% hydrogen by partial pressure with the remainder being one or more selected from nitrogen and a noble gas for a time period of at least about 45 minutes to form a sintered copper-based material having a grain size greater than 50 μm.

11. The method according to claim 10, wherein the second sintering act is performed under a lower partial pressure of hydrogen than the first sintering act.

12. The method according to claim 10, further comprising heating the compacted metal powder at a temperature of at least about 400° C. under an atmosphere comprising at least about 5% hydrogen by partial pressure with the remainder being one or more selected from nitrogen and a noble gas after the compacting act and before the first sintering act; and
heating the sized copper-based material at a temperature of at least about 400° C. under an atmosphere comprising at least about 5% hydrogen by partial pressure with the remainder being one or more selected from nitrogen and a noble gas after the pressure application act and before the second sintering act.

13. The method according to claim 10, wherein the second pre-heating act is performed under a lower partial pressure of hydrogen than the first pre-heating act.

14. The method according to claim 10, wherein the first and second sintering acts are each independently performed for a time period of at least about 50 minutes.

15. A sintered copper-based material, comprising:
a crystallized metal matrix formed from a powdered metal comprising at least about 70% by weight copper, the crystallized metal matrix comprising grains where at least 80% by weight of the grains have a grain size greater than 50 μm.

16. The sintered copper-based material according to claim 15, wherein the crystallized metal matrix comprises at least about 80% by weight copper.

17. The sintered copper-based material according to claim 15, wherein the crystallized metal matrix comprises at least about 90% by weight copper.

18. The sintered copper-based material according to claim 15, wherein the crystallized metal matrix comprises grains where at least 80% by weight of the grains have a grain size greater than 100 μm.

19. The sintered copper-based material according to claim 15, wherein the crystallized metal matrix comprises grains where at least 90% by weight of the grains have a grain size greater than 75 μm.

20. The sintered copper-based material according to claim 15, wherein the crystallized metal matrix comprises grains where at least 90% by weight of the grains have a grain size greater than 125 μm.
